(19) United States
(12) Patent Application Publication
(10) Pub. No.: US 2010/0102906 A1
(43) Pub. Date: Apr. 29, 2010

(54) MAGNETICALLY OPERATED SWITCH

(75) Inventor: Joshua Lanter, Western Australia (AU)

Correspondence Address: BUCHANAN, INGERSOLL & ROONEY PC, POST OFFICE BOX 1404, ALEXANDRIA, VA, 22313-1404, US

(73) Assignee: POLYCONTACT AG, Chur (CH)

(21) Appl. No.: 12/525,973

(22) PCT Filed: Jan. 7, 2008
(86) PCT No.: PCT/CH08/00008

§ 371 Date: Aug. 5, 2009

(30) Foreign Application Priority Data
Feb. 6, 2007 (CH) 192/07

(51) Int. Cl. H01H 36/00; A44B 99/00

(52) U.S. Cl. 335/205; 24/593.1

(57) ABSTRACT

A magnetically operated switch is disclosed, which has at least two electrical contacts and a permanent-magnet actuation device, at least regions of which are electrically conductive, which contacts and device can be arranged in a common housing. The magnetic actuation device in a first end position electrically conductively bridges the two contacts and, in the event of the presence of an attractor component, which interacts magnetically with the device, can be moved into a second end position, in which the electrical connection between the two contacts is interrupted. At least one of the electrical contacts can be made from a ferromagnetic material and/or coated with a ferromagnetic material. The magnetic attractive force between the ferromagnetic contact and the magnetic actuation device can be smaller than the magnetic attractive force between the magnetic actuation device and the attractor component.

### RELATED APPLICATIONS

This application claims priority as a continuation application under 35 U.S.C. §120 to PCT/CH2008/000008, which was filed as an International Application on Jan. 7, 2008 designating the U.S., and which claims priority to Swiss Application 192/07 filed in Switzerland on Feb. 6, 2007. The entire contents of these applications are hereby incorporated by reference in their entireties.

### FIELD

The disclosure relates to a magnetically operated switch for interrupting and/or closing an electrical circuit. The disclosure also relates to the use of such a magnetically operated switch as a state sensor, usable, for example, in a belt lock of a safety belt.

### BACKGROUND INFORMATION

Switches are known devices for interrupting and/or closing electrical circuits. They can include of contacts which are suitable for the respective electrical loading by current or voltage and of an actuation means for bridging the contacts. The actuation device can be of a mechanical or electromechanical nature. These switches are for example rotary, toggle, stepping or momentary contact switches, and/or relays.

In the course of miniaturization, solid-state switches and mechanical microswitches have also been developed. Solid-state switches ordinarily possess source, drain and gate terminals, and are suitable for switching small currents. Microswitches are relatively complex in construction and include contact springs and the like in order to implement the two switching states “on” and “off”. Contact springs are wearing parts which can fatigue and even fail when the switch is intensively used.

Switching devices are known which are based on the magnetic principle. U.S. Pat. No. 6,803,845 describes for example a magnetically operated switch which is used as a monitoring switch in doors or switches. The magnetically operated switch has two current contacts, an electrically conductive, permanent magnetic actuation device and a ferromagnetic attractor component which are located in a housing which is attached for example to a door frame or window frame. A second ferromagnetic attractor component is mounted on the door or on the window wing. In relative movement of the first and second attractor components the actuation means is moved out of a first end position in which for example the circuit is closed, into a second end position in which the circuit is interrupted. This proposed arrangement still includes a relatively large amount of space; when used as a monitoring switch for doors or windows this is of subordinate importance. This arrangement is less well suited for components installed under narrowed space conditions.

In the automobile industry Hall sensors are used for example as proximity state sensors for the state of belt locks of safety belt means. Knowledge of the state of the belt lock is used to indicate to the passengers by a signal that the safety belts have been put on and locked. Since the introduction of safety airbags, information about the closed state of the safety belts can also be important for control of the activation or deactivation of mechanisms for inflating driver and passenger airbags or side airbags.

EP-A-0 861 763 discloses a belt lock with an integrated pretensioned Hall sensor which detects the state of the locking body or ejector for a lock tongue which has been inserted into the belt lock, without contact. Here the Hall sensors with the Hall field are located in the immediate vicinity of the a permanent magnet. By changing the location of the locking body or the ejector which include a ferromagnetic material for this purpose, the magnetic field of the permanent magnet is changed. This changes the signal of the Hall sensor and at the output of the Hall sensor the change of the state can be tapped as a change of voltage. In one alternative version, the Hall sensor with the Hall field is installed without a permanent magnet and for this reason the locking body or ejector is made as a permanent magnet. In this arrangement the change in the position of the locking body or of the ejector is to be detectable by a change of the Hall voltage.

With the belt lock disclosed in EP-A-0 861 763, the Hall sensor is positioned very carefully with respect to the locking element or the ejector. Subsequent installation of the Hall sensor can therefore be relatively complex and expensive. The Hall sensor is moreover relatively sensitive to external stray fields which, for example, can be caused by a magnetic key ring. Optionally even additional shielding is attached; this can further complicate the structure or installation. The susceptibility to external stray fields can also be increased by the signal changes being relatively small due to the comparatively short distances which are traversed in closing or opening of the safety belt lock by the locking body or the ejector. The belt lock version without the pretensioned Hall sensor in which either the locking body or the ejector is made as a permanent magnet is also less practicable. The attainable signal changes can also be relatively small here. Demagnetization can occur over time due to vibrations of the locking body and of the ejector when the safety belt is opened or closed. Ultimately this leads to the Hall sensor becoming ineffective and the state changes of the belt lock no longer being detectable.

### SUMMARY

A magnetically operated switch is disclosed comprising: at least two electrical contacts; and a permanent magnetic actuation means electrically conductive at least in regions, and located in a common housing with the electrical contacts, the magnetic actuation means in a first end position bridging the electrical contacts in an electrically conductive manner and in a presence of an attractor component which magnetically interacts with the magnetic actuation means, being movable into a second end position in which electrical connection between the two contacts is interrupted, wherein at least one of the electrical contacts contains a ferromagnetic material, and a magnetic attraction force between the ferromagnetic material and the magnetic actuation means is smaller than another magnetic attraction force between the magnetic actuation means and the attractor component.

A belt lock for a safety belt means of a vehicle is disclosed, with the belt comprising: a locking mechanism; and a state sensor which monitors a component which changes position when the locking mechanism is actuated, wherein the state sensor is formed by a magnetically operated switch which includes: at least two electrical contacts; and a permanent magnetic actuation means electrically conductive at least in regions, and located in a common housing with the electrical contacts, the magnetic actuation means in a first end position bridging the electrical contacts in an electrically conductive manner and in a presence of an attractor component which magnetically interacts with the magnetic actuation means, being movable into a second end position in which electrical connection between the two contacts is interrupted, wherein at least one of the electrical contacts contains a ferromagnetic material, and a magnetic attraction force between the ferromagnetic material and the magnetic actuation means is smaller than another magnetic attraction force between the magnetic actuation means and the attractor component.

### BRIEF DESCRIPTION OF THE DRAWINGS

Other advantages and features of the disclosure will become apparent from the following description of embodiments of a magnetically operated switch. The figures are schematic.

FIG. 1 shows a schematic of a first exemplary embodiment of a magnetically operated switch;

FIG. 2 shows a second exemplary embodiment of the magnetically operated switch;

FIG. 3 shows a third exemplary embodiment of the magnetically operated switch;

FIG. 4 shows a version of the magnetically operated switch from FIG. 3;

FIG. 5 shows a schematic of an exemplary magnetically operated switch which is made as a ganged control switch;

FIG. 6 shows an exemplary magnetically operated switch made as a two-way switch;

FIG. 7 shows a schematic of an exemplary closure of a safety belt means; and

FIG. 8 shows an exemplary cross section of a belt lock of the safety belt means as shown in FIG. 7 with a magnetically operated switch.

### DETAILED DESCRIPTION

An exemplary magnetically operated switch is disclosed which can have a simple and space-saving structure and which can be economically produced. The magnetically operated switch can be usable as a replacement for known magnetic switches, for microswitches, reed switches or Hall switches. It is also usable under narrow space conditions. The magnetically operated switch can also be suitable for installation in belt lock systems of known safety belt systems.

A magnetically operated switch is disclosed which has at least two electrical contacts and a permanent magnetic actuation means, which is electrically conductive at least in regions, which are located in a common housing. The magnetic actuation means in a first end position bridges the two contacts in an electrically conductive manner and in the presence of an attractor component which magnetically interacts with it can be moved into a second end position in which the electrical connection between the two contacts is interrupted. At least one of the electrical contacts contains (e.g., consists of) a ferromagnetic material (e.g., a base material and/or a coating of a ferromagnetic material). In an exemplary embodiment, the magnetic attraction force between the ferromagnetic contact and the magnetic actuation means is smaller than the magnetic attraction force between the magnetic actuation means and the magnetically interacting attractor component.

In its simplest version, the magnetically operated switch includes (e.g., consists of) two electrical contacts and the permanent magnetic actuation means which in one end position electrically connects the two electrical contacts. In an exemplary embodiment, a sole moving part is the permanent magnetic actuation means which can be moved into the second end position when the attractor component which interacts magnetically with it is present. In this way the electrical connection between the two electrical contacts is interrupted. Pretensioning elements such as for example contact springs or the like can be omitted. The attractor component can be a component of ferromagnetic material or even a magnet or can contain one. The magnetically operated switch does not require a separate second attractor component in order to assume the first switching position since at least one of the electrical contacts is ferromagnetic. In this way the construction of the magnetically operated switch can be made still smaller relative to known switches. For this reason the magnetically operated switch is also very well suited to use under narrowed space conditions. All components of the magnetically operated switch are accommodated in a common housing which can be sealed and insulated very easily; in this way the most varied sealing and insulation requirements for these switches, such as for example IP67, IP68, IP69, can be very easily satisfied. The contact zone is bridged with magnetic force. In this way the contact region can also be made line-shaped. An exemplary prerequisite for this is that the contacts are made elastic; this can generally be done very easily. The costs for the components can be low. The effort for mounting the magnetically operated switch which encompasses only three components in a simple version in the housing is likewise low. In this way the magnetically operated switch can be produced very economically.

The permanent magnetic actuation means can include (e.g., consist entirely of) an electrically conductive material. For example, the magnetic actuation means can be coated with contact material, especially on its contact surface. In this way also relatively strong magnets of SmCo, NdFeB, ceramic materials, hard ferrite and the like can be used.

For reasons of especially good conductivity the contact material can be chosen from the group consisting of silver, gold, other electrically conductive precious metals, nickel, iron and a combination of any two or more of these materials.

In one exemplary version of the disclosure the ferromagnetic electrical contact is made of one of the known contact materials and consists especially of a material from the group consisting of iron, nickel, silver, gold, other electrically conductive precious metals or a combination of any two or more of these materials.

In order to obtain greater flexibility with respect to materials for the electrical contact, the ferromagnetic contact in another exemplary version of the disclosure is coated with a contact material, such as with a material from the group consisting of nickel, silver, gold, other electrically conductive precious metals or a combination of any two or more of these materials.

In the actuation of the magnetically operated switch the permanent magnetic actuation means can be moved completely away from the two electrical ones. One version of the disclosure calls for the second electrical contact to be fixedly (e.g., permanently) connected to the permanent magnetic actuation means.

The switching motion of the permanent magnetic actuation means in the presence of an attractor component which interacts magnetically with it out of its first end position into the second end position can take place in different ways. In one exemplary version of the magnetically operated switch the actuation means can be moved parallel. The parallel displacement within the housing takes place in a controlled guided manner. The walls of the housing are used for guidance here.

In one alternative exemplary version of the magnetically operated switch the permanent magnetic actuation means in the presence of an attractor component which interacts magnetically with it can be pivoted such that the electrical contact to the ferromagnetic contact is interrupted. For example, the second electrical contact can be made as a pivoting axle for the permanent magnetic actuation means. The version with the pivotable actuation means allows very small actuator travels. The actuator travels in the displacement of the actuation means from the first into the second end position are, for example, roughly 0.2 mm to roughly 2 mm (or greater or lesser as desired).

A magnetically operated switch as disclosed herein can be made in another embodiment also as a ganged control switch or as a two-way switch. For this reason in the housing there is at least one other electrical contact. The permanent magnetic actuation means in the presence of an attractor component which interacts magnetically with it can be moved into the second end position in which it then comes into contact with at least one other electrical contact and closes the electrical circuit.

In order to be able to better define the initial end position of the magnetically operated switch, in another exemplary version of the disclosure the two electrical contacts which are electrically connected in the first end position of the permanent magnetic actuation means are made of a ferromagnetic material and/or are coated with one.

Due to a simple structure and small size, exemplary magnetically operated switches as disclosed herein are especially suitable as, for example, a sensor for the closed state of a belt lock of a safety belt means.

In a belt lock equipped with a magnetically operated switch as disclosed herein for a safety belt means of a motor vehicle or the like with a locking mechanism, the magnetically operated switch forms a state sensor which monitors a component which changes its location when the locking mechanism is actuated. In this case the monitored component can be advantageously the lockable lock tongue of the safety belt means which can be inserted into the lock. In this way not just any secondary component which can be moved in locking is monitored, but monitoring is done directly on the safety-relevant component.

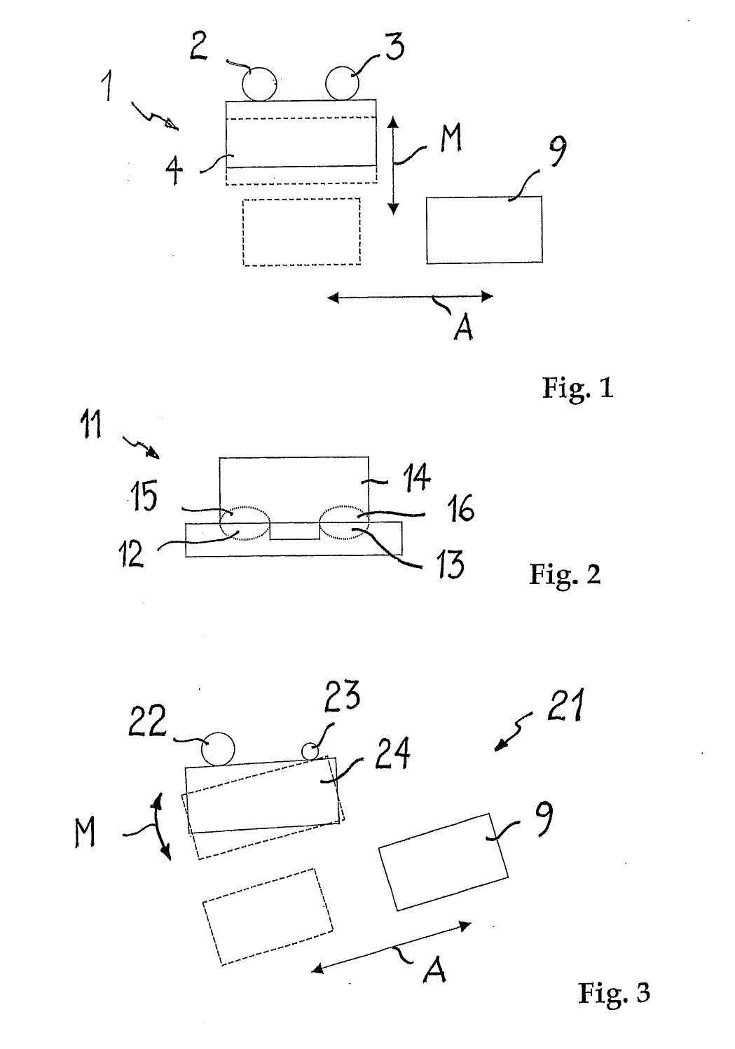

In the schematic of FIG. 1 the schematically depicted magnetically operated switch is labelled 1 overall. It comprises at least two electrical contacts 2, 3 and a permanent magnetic actuation means 4 which is electrically conductive at least in regions. The two electrical contacts 2, 3 and the permanent magnetic actuation means 4 are located in a housing (e.g., a common housing) of FIG. 1. The permanent magnetic actuation means 4 is movably arranged such that it can be moved out of a first end position in which it is in contact with the two electrical contacts 2, 3 and closes a circuit, into a second end position in which the electrical circuit is interrupted. The permanent magnetic actuation means 4 in the initial state can be in the first end position in which it closes the electrical circuit by way of the two electrical contacts 2, 3. This can be achieved by at least one of the electrical contacts 2, 3 including (e.g., consisting of) a ferromagnetic material and/or being coated with one. The magnetic attraction force between the permanent magnetic actuation means 4 and at least one electrical contact keeps the permanent magnetic actuation means 4 in its stable first end position. In the embodiment shown in FIG. 1 the two electrical contacts include (e.g., consist of) a ferromagnetic material and/or are coated with one.

If an attractor component 9 is located in the vicinity of the magnetically operated switch 1 which exerts on the permanent magnetic actuation means 4 a greater magnetic attraction force than the electrical contacts, the permanent magnetic actuation means 4 within the housing is shifted into the second end position in which the electrical circuit between the two electrical contacts 2, 3 is interrupted. The attractor component can be a ferromagnetic component or a magnet or can contain one. If the magnetically interacting attractor component 9 is again moved away from the magnetically operated switch 1, the permanent magnetic actuation means 4 returns again to the first end position and closes the circuit between the two electrical contacts 2, 3. The second end position of the permanent magnetic actuation means 4 and the pertinent location of the attractor component 9 are indicated in FIG. 1 by a broken line. The two double arrows M and A indicate changes in the location of the attractor component 9 and the permanent magnetic actuation means 4.

The permanent magnetic actuation means 4 can include (e.g., consist entirely of) an electrically conductive material. For example, it can be coated, especially on its contact surface, with contact material. In this way also relatively strong magnets of SmCo, NdFeB, ceramic materials, hard ferrite, and the like can be used. The larger the magnetic field generated by the permanent magnetic actuation means 4, the greater the distance can be in which the ferromagnetic attractor component 9 is guided to the magnetically operated switch 1. The contact materials can be for example silver, gold, other electrical conductive precious metals, nickel, iron and combinations of two or more of these materials. The ferromagnetic electrical contacts 2, 3 can include (e.g., consist of) these materials of very good conductivity or can be coated with these materials.

FIG. 2 schematically shows one version of a magnetically operated switch labelled 11 in which the electrical contacts 12, 13 are made as contact zones. Analogous contact zones 15, 16 are made on the permanent magnetic actuation means 14.

The embodiment of the magnetically operated switch shown in FIG. 3 is labelled 21 overall. It has in turn two electrical contacts 22, 23 and a permanent magnetic actuation means 24 which are located in a common housing which is not detailed. In the illustrated embodiment only the electrical contact 22 which is shown larger includes (e.g., consists of) a ferromagnetic material or it is coated with one. It goes without saying that the electrical contacts 22, 23 are shown in different sizes only for explanation of the different execution. In reality the electrical contacts have the same size. The magnetically interacting attractor component is in turn labelled 9. If this 9 is moved into the vicinity of the magnetically operated switch 21 the permanent magnetic actuation means 24 is moved into its second end position by the magnetic attraction force which prevails between it and the attractor component 9. According to the illustrated embodiment of the magnetically operated switch 21, by pivoting the permanent magnetic actuation means 24 only contact to the ferromagnetic electrical contact 22 is interrupted. The second electrical contact 23 can form the pivoting axis for the actuation means 24. The movements of the permanent magnetic actuation means 24 and the attractor component 9 are indicated in turn by the double arrows M and A. The second end position of the permanent magnetic actuation means 24 and the pertinent location of the attractor component 9 are shown by the broken line.

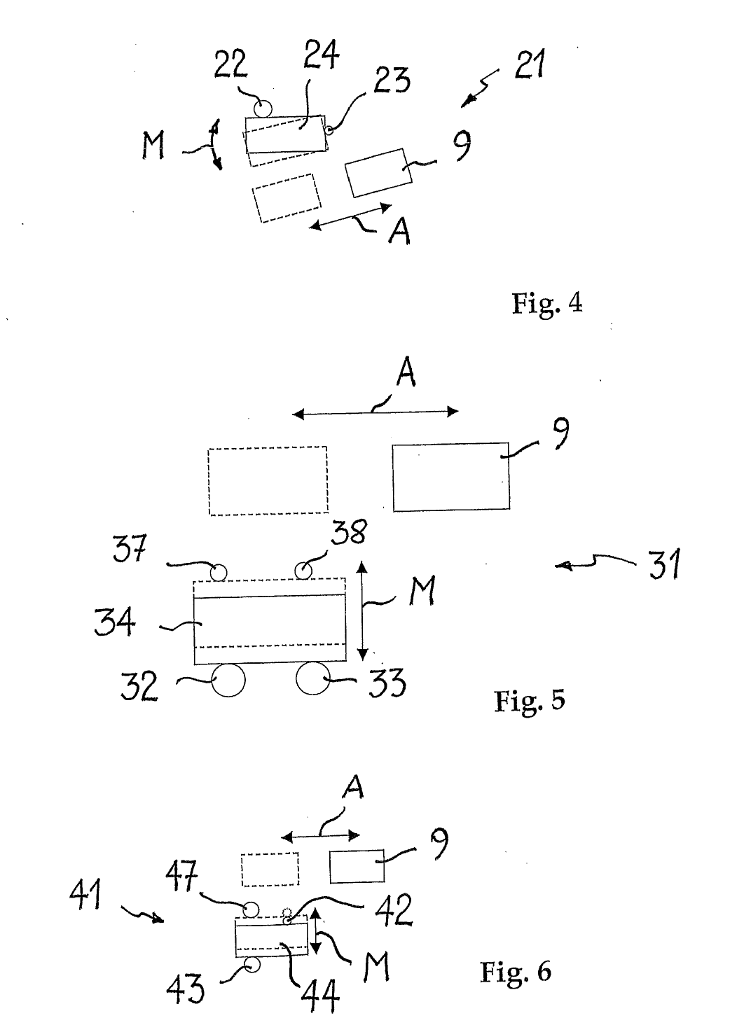

As is apparent from the FIG. 4 version of the magnetically operated switch 21 shown in FIG. 3, the electrical contacts 22, 23 need not be unconditionally located on the same side of the actuation means 24. The electrical contact 23 which is not made ferromagnetic can also be connected to the wide side of the actuation means 24. The movements of the permanent magnetic actuation means 24 and the attractor component 9 which interacts magnetically with it are in turn indicated by the double arrows M and A. The second end position of the permanent magnetic actuation means 24 and the pertinent location of the attractor component 9 are shown by the broken line.

FIG. 5 shows another exemplary embodiment of a magnetically operated switch which is labelled 31 overall. In particular the magnetically operated switch 31 is made as a ganged control switch. For this purpose, within a common housing there are a permanent magnetic actuation means 34 and two pairs of electrical contacts 32, 33 and 37, 38. The pairs of electrical contacts 32, 33 and 37, 38 are located on the opposing lengthwise sides of the actuation means 34 and belong to the two different circuits. The first end position of the permanent magnetic actuation means 34 can be ensured by a ferromagnetic execution of the two electrical contacts 32, 33 of the first electrical circuit. The second contact pair 37, 38 is not made ferromagnetic; this is indicated in FIG. 5 in turn by the smaller size of the electrical contacts 37, 38. So that the permanent magnetic actuation means 34 is moved into the second end position, an attractor component 9 which interacts magnetically with it is moved into the vicinity of the nonferromagnetic electrical contacts 37, 38. Because the magnetic attraction force between the attractor component 9 and the permanent magnetic actuation means 34 is larger than the magnetic attraction force to the ferromagnetic contacts 32, 33, the actuation means 34 is displaced. In this connection the electrical contact to the two ferromagnetic contacts 32, 33 is interrupted, while the two other electrical contacts 37, 38 are conductively connected. If the attractor component 9 is moved away again, the permanent magnetic actuation means 34 is attracted again by the ferromagnetic contacts 32, 33, and it moves again into the first end position in which the first circuit is closed. The movements of the permanent magnetic actuation means 34 and the attractor component 9 are in turn indicated by the double arrows M and A. The second end position of the permanent magnetic actuation means 34 and the pertinent location of the attractor component 9 are indicated by a broken line.

FIG. 6 schematically shows a magnetically operated switch which is made as a two-way switch and which is labelled 41 overall. Within the common housing which in turn is not detailed there is a permanent magnetic actuation means 44 which is fixedly (e.g., permanently) connected to an electrical contact 42. There are two other electrical contacts 43 and 47 on the opposite lengthwise sides of the permanent magnetic actuation means 44. To fix the first end position of the permanent magnetic actuation means 44 the first of these electrical contacts 43 is made ferromagnetic. The other second electrical contact 47 and the electrical contact connected to the actuation means 44 can likewise be made ferromagnetic or also non-ferromagnetic. The magnetic attraction force between the first ferromagnetic electrical contact 43 and the permanent magnetic actuation means 44 is greater than that to the second electrical contact 47 on the opposite lengthwise side of the actuation means 44. In this way, in the first end position of the actuation means 44 the contacts 42, 43 are electrically connected. For purposes of switchover, an attractor component 9 can be moved into the vicinity of the second electrical contact 47 whose magnetic attraction force to the permanent magnetic actuation means 44 is greater than that between the actuation means 44 and the ferromagnetic first electrical contact 43. In this way the actuation means 44 can be moved into its second end position, for example pushed in parallel. In this regard the electrical conductor 42 which is fixedly (e.g., permanently) connected to the actuation means 44 can be moved at the same time and is electrically connected to the second electrical contact 47, while the electrical connection to the first electrical contact 43 is separated. If the attractor component 9 is moved away again, the permanent magnetic actuation means returns again into its first end position by the magnetic attraction force to the first electrical contact 43 and forms an electrical connection between the contacts 42 and 43. The movements of the permanent magnetic actuation means 44 and the attractor component 9 are in turn indicated by the double arrows M and A. The second end position of the permanent magnetic actuation means 44 and the pertinent location of the attractor component 9 are indicated by the broken line.

In the illustrated versions of the magnetically operated switch, pretensioning elements such as for example contact springs or the like can be omitted. The magnetically operated switch does not require a separate ferromagnetic component in order in the first stable end position of the permanent magnetic actuation means to assume the first switching position since at least one of the electrical contacts is made ferromagnetic. In this way the construction of the magnetically operated switch can be made even smaller relative to the known switches and the magnetically operated switch is also very well suited for use under narrowed space conditions. All components of the magnetically operated switch are accommodated in a common housing which can be sealed and insulated very easily. In this way the most varied sealing and insulation requirements for these switches, such as for example IP67, IP68, IP69, can be very easily satisfied. The contact zone is bridged with magnetic force. In this way the contact region can also be made line-shaped. The prerequisite for this is that the contacts are made elastic; this can generally be implemented very easily. The costs for the components are low. The effort for mounting the magnetically operated switch which encompasses only three components in the simplest version in the housing is likewise small. In this way the magnetically operated switch disclosed herein can be produced very economically.

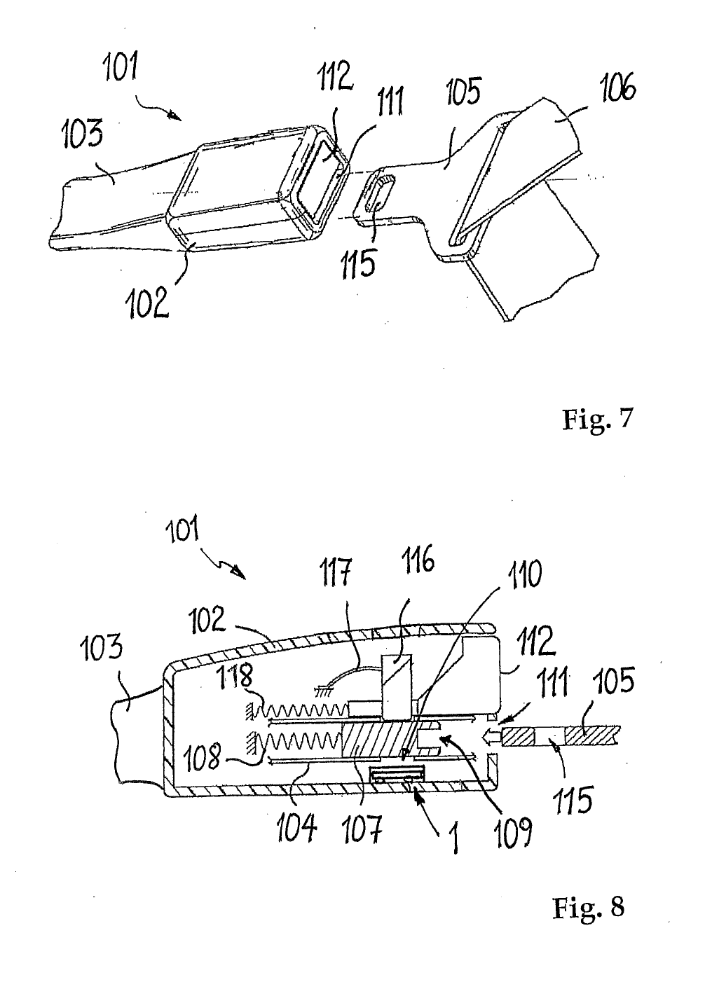

One exemplary application of the magnetically operated switch is as a sensor for the closed state of a belt lock of a safety belt means which is shown schematically in FIG. 7. The illustrated belt lock is labelled 101 overall and has a known external structure. The belt lock 101 is located on the end of the belt anchor 103 and is used for receiving and detachable interlocking of the lock tongue 105 which is connected to the safety belt 106. The belt lock 101 has a housing 102 which is made open on its side facing away from the belt anchor 103. An unlocking button 112 for a locking mechanism located within the housing 2 extends over most of the open housing region and leaves an insertion slot 111 for the lock tongue 105 open. The locking mechanism when the lock tongue 105 is inserted through the insertion slot 111 latches in the tongue recess 115. The lock tongue 105 is released by actuating the unlocking button 112.

The schematic cross section of FIG. 8 shows an exemplary structure of a belt lock 101 which is equipped with a magnetically operated switch 1 as disclosed herein which is used as a sensor for the locked state of the belt lock 101. In particular, FIG. 8 shows the locking mechanism which is located within the housing 102 for the lock tongue 105 which has been inserted through the insertion slot 111. The locking mechanism can be made in any known manner. It comprises a frame 104 with a guided ejector 107 which is pretensioned by a compression spring 108 in the direction of the insertion slot 111. On its end side facing the insertion slot 111 the ejector 107 has a tongue receiver 109. The lock tongue 105 is inserted into the housing 102 against the spring force of the compression spring 108. As soon as it has been inserted so far that the tongue recess 115 is aligned with the recess 110 in the frame 104, a locking body 116 which is located on a rocker 117 moves through the tongue recess 115 in the direction of the recess 110 and fixes the lock tongue 105. The release of the lock tongue 105 takes place by actuating the unlocking button 112 against the spring force of a pretensioning spring 118. In this connection the locking body 116 is retracted from the tongue recess 115 and the spring-loaded ejector 107 pushes the lock tongue 105 in the direction of the insertion slot 111. At the same time the ejector 107 prevents movement of the locking body 116 in the direction of the recess 110 in the frame 104.

A magnetically operated switch 1 which has for example the construction of the embodiment explained using FIG. 1 is located underneath the frame 104, for example in the region of the recess 110 for the locking body 116. The magnetically operated switch 1 has the function of a sensor for the closed state of the belt lock 101. Depending on whether the belt tongue 105 or the locking body 116 is ferromagnetic, or is made as a magnet or contains a magnet, with the magnetically operated switch 1 the location of the belt tongue 105 or of the locking body 116 can be monitored. If for example the belt tongue 105 is made ferromagnetic or itself is a magnet, it performs the function of the attractor component which is responsible for changing the switching state of the magnetically operated switch 1, as the magnetically operated switch 1 is approached. Only when the belt tongue 105 has been completely inserted through the insertion slot 11 and is being held in position by the locking body 116 is the location of the permanent magnetic actuation means changed and it assumes the second end state in which it for example interrupts a circuit. In this way for example a warning light for putting on the safety belt on the dashboard goes out. In the execution of the magnetically operated switch as a ganged control switch for example a circuit can be additionally closed which signals the airbag means that the passenger is belted, etc. Instead of the belt tongue 105, the locking body 116 can also be made ferromagnetic or can be a magnet or can have a magnet and can be used for monitoring the closed state of the belt lock 101. Both components 105, 116 can also be made ferromagnetic or can be magnets. In another embodiment of the belt lock the ejector is provided with a magnet whose displacement causes changeover of the magnetically operated switch when the lock tongue is inserted.

The magnetically operated switch as disclosed herein can be structured very simply, can be invulnerable to vibration and wear very little.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Magnetically operated switch, comprising:
at least two electrical contacts; and
a permanent magnetic actuation means electrically conductive at least in regions, and located in a common housing with the electrical contacts, the magnetic actuation means in a first end position bridging the electrical contacts in an electrically conductive manner and in a presence of an attractor component which magnetically interacts with the magnetic actuation means, being movable into a second end position in which electrical connection between the two contacts is interrupted, wherein at least one of the electrical contacts contains a ferromagnetic material, and a magnetic attraction force between the ferromagnetic material and the magnetic actuation means is smaller than another magnetic attraction force between the magnetic actuation means and the attractor component.

2. Magnetically operated switch as claimed in claim 1, wherein the permanent magnetic actuation means on a contact surface is coated with a contact material.

3. Magnetically operated switch as claimed in claim 2, wherein the contact material is chosen from the group consisting of: silver, gold, other electrically conductive precious metals, nickel, iron and a combination of these materials.

4. Magnetically operated switch as claimed in claim 1, wherein the ferromagnetic material is a material selected from the group consisting of: iron, nickel, silver, gold, electrically conductive precious metals and a combination of two or more of these materials.

5. Magnetically operated switch as claimed in claim 1, wherein the ferromagnetic material is a coating selected from the group consisting of: nickel, silver, gold, other electrically conductive precious metals and a combination of two or more of these materials.

6. Magnetically operated switch as claimed in claim 1, wherein the permanent magnetic actuation means is fixedly connected to a second of the at least two electrical contacts.

7. Magnetically operated switch as claimed in claim 1, wherein the permanent magnetic actuation means in the presence of the attractor component which interacts magnetically with the magnetic actuation means, is configured to move in parallel out of the first end position into the second end position.

8. Magnetically operated switch as claimed in claim 1, wherein the permanent magnetic actuation means in the presence of the attractor component which interacts magnetically with the magnetic actuation means, is configured to pivot such that the electrical contact to the ferromagnetic contact is interrupted.

9. Magnetically operated switch as claimed in claim 8, wherein the second of the at least two electrical contacts is made as a pivoting axle for the permanent magnetic actuation means.

10. Magnetically operated switch as claimed in claim 1, wherein the actuator travel traversed by the permanent magnetic actuation means in the presence of the attractor component which interacts magnetically with the magnetic actuation means is 0.2 mm to 2 mm.

11. Magnetically operated switch as claimed in claim 1, wherein the permanent magnetic actuation means in the presence of the attractor component which interacts magnetically with the magnetic actuation means, is configured to move into the second end position in which the magnetic actuation means comes into contact with at least one other electrical contact and closes the electrical circuit.

12. Magnetically operated switch as claimed in claim 1, wherein the two electrical contacts which are electrically connected in the first end position of the permanent magnetic actuation means include ferromagnetic material.

13. A magnetically operated switch as claimed in claim 1, configured as a sensor for sensing a closed state of a belt lock of a safety belt means.

14. Belt lock for a safety belt means of a vehicle, with the belt comprising:
a locking mechanism; and
a state sensor which monitors a component which changes position when the locking mechanism is actuated, wherein the state sensor is formed by a magnetically operated switch which includes:
at least two electrical contacts; and
a permanent magnetic actuation means electrically conductive at least in regions, and located in a common housing with the electrical contacts, the magnetic actuation means in a first end position bridging the electrical contacts in an electrically conductive manner and in a presence of an attractor component which magnetically interacts with the magnetic actuation means, being movable into a second end position in which electrical connection between the two contacts is interrupted, wherein at least one of the electrical contacts contains a ferromagnetic material, and a magnetic attraction force between the ferromagnetic material and the magnetic actuation means is smaller than another magnetic attraction force between the magnetic actuation means and the attractor component.

15. Belt lock as claimed in claim 14, wherein the monitored component is a lock tongue of the safety belt means which can be inserted into the lock and locked.

16. Magnetically operated switch as claimed in claim 3, wherein the ferromagnetic material is a material selected from the group consisting of: iron, nickel, silver, gold, electrically conductive precious metals and a combination of two or more of these materials.

17. Magnetically operated switch as claimed in claim 3, wherein the ferromagnetic material is a coating selected from the group consisting of: nickel, silver, gold, other electrically conductive precious metals and a combination of two or more of these materials.

18. Magnetically operated switch as claimed in claim 4, wherein the permanent magnetic actuation means is fixedly connected to a second of the at least two electrical contacts.

19. Magnetically operated switch as claimed in claim 18, wherein the two electrical contacts which are electrically connected in the first end position of the permanent magnetic actuation means include a ferromagnetic material.

20. A magnetically operated switch as claimed in claim 19, configured as a sensor for sensing a closed state of a belt lock of a safety belt means.
